(19) United States
(12) Patent Application Publication
(10) Pub. No.: US 2017/0013116 A1
(43) Pub. Date: Jan. 12, 2017

(54) METHOD, APPARATUS AND COMPUTER-READABLE MEDIUM FOR TRAVEL PATH CONDITION PROMPT

(71) Applicant: Xiaomi Inc., Beijing (CN)

(72) Inventors: Liang Zhang, Beijing (CN); Liangxiong Wu, Beijing (CN); Peng Zhou, Beijng (CN)

(73) Assignee: Xiaomi Inc., Beijing (CN)

(21) Appl. No.: 15/195,336

(22) Filed: Jun. 28, 2016

(30) Foreign Application Priority Data
Jul. 9, 2015 (CN) 201510400560.0

(51) Int. Cl. H04M 1/725; G01S 17/02; G08B 21/04; G01S 15/04; H04W 4/02; H04M 1/02

(52) U.S. Cl. CPC H04M 1/72569; H04W 4/027; H04M 1/0202; G08B 21/0469; G08B 21/0461; G01S 15/04; G01S 17/026; H04M 2203/252

(57) ABSTRACT

Method, apparatus and computer-readable medium for detecting a condition for an surrounding environment of a mobile device are disclosed. The mobile device may generate a prompting information and control presentation of the prompting information based on at least the detected condition of the surrounding environment.

### CROSS-REFERENCE TO RELATED APPLICATIONS

This application claims priority to Chinese Patent Application No. 201510400560.0, filed on Jul. 9, 2015, the entirety of which is hereby incorporated by reference herein.

### FIELD

The present disclosure generally relates to mobile device technology, and more particularly to a method, apparatus and computer-readable medium for generating a travel path condition prompt based on a condition detected by a mobile device.

### BACKGROUND

Mobile devices having a light source may be used as a portable flashlight to provide illumination under various circumstances. When a user is walking at night or in other low light condition, the user may attempt to use the flashlight feature of a mobile device to illuminate the path ahead of the user. However, the illumination provided by the light source of a mobile device may not provide sufficient coverage to avoid obstacles or hazards in the user's path.

### SUMMARY

In view of the related arts, a method, apparatus and computer-readable medium for generating a travel path condition prompt are provided in the disclosure.

According to a first exemplary embodiment of the present disclosure, a method for travel path condition prompt is provided, including: detecting condition of a travel path within a predetermined range when a trigger instruction for a predetermined function in a mobile device is received; and outputting prompt information if there is an obstacle on the travel path within the predetermined range.

According to a second exemplary embodiment of the present disclosure, a mobile device is provided, including: a processor; a memory to store processor-executable instructions; wherein the processor is configured to: detect condition of a travel path within a predetermined range when a trigger instruction for a predetermined function in a mobile device is received; and output prompt information if there is an obstacle on the travel path within the predetermined range.

According to a third exemplary embodiment of embodiments of the present disclosure, there is provided a non-transitory computer readable storage medium having stored therein instructions that, when executed by a processor of a mobile device, cause the mobile device to: detect condition of a travel path within a predetermined range when a trigger instruction for a predetermined function in the mobile device is received; and output prompt information if there is an obstacle on the travel path within the predetermined range.

### BRIEF DESCRIPTION OF THE DRAWINGS

FIG. 1 shows a flow chart showing a method for generating a travel path condition prompt according to an exemplary embodiment.

FIG. 2 shows a flow chart showing a method for generating a travel path condition prompt according to an exemplary embodiment.

FIG. 3 shows a schematic diagram illustrating a predetermined range of a mobile device according to an exemplary embodiment.

FIG. 4 shows a schematic diagram illustrating an obstacle according to an exemplary embodiment.

FIG. 5 shows a schematic diagram illustrating an obstacle according to an exemplary embodiment.

FIG. 6 shows a structure diagram illustrating an apparatus for travel path condition prompt according to an exemplary embodiment.

FIG. 7 is a block diagram illustrating a mobile device according to an exemplary embodiment.

### DETAILED DESCRIPTION

Reference will now be made in detail to exemplary embodiments, examples of which are illustrated in the accompanying drawings. The following description refers to the accompanying drawings in which same numbers in different drawings represent same or similar elements unless otherwise described. The implementations set forth in the following description of exemplary embodiments do not represent all implementations consistent with the invention. Instead, they are merely examples of apparatuses and methods consistent with aspects related to the invention as recited in the appended claims.

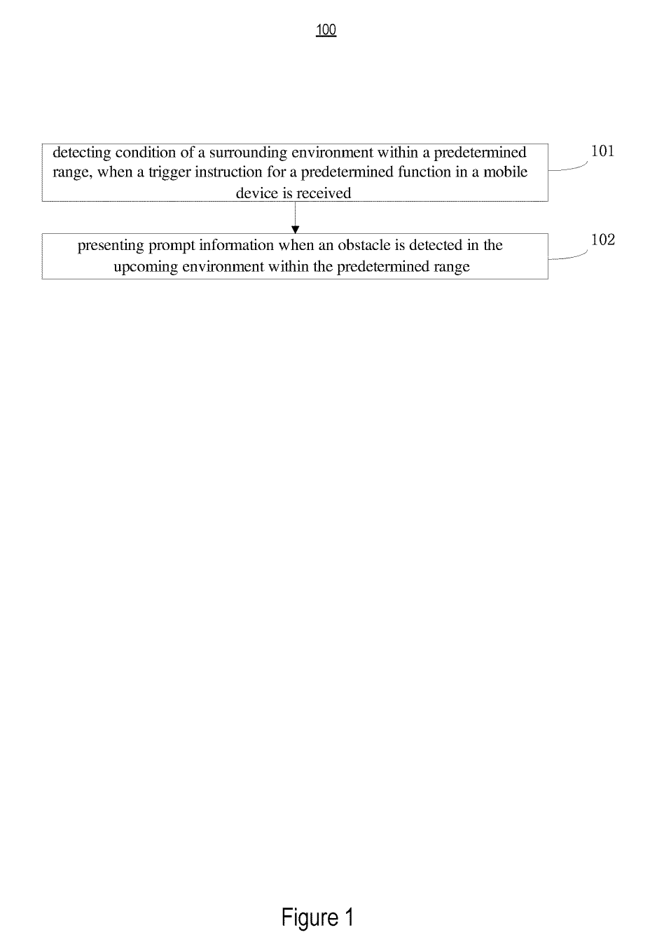

FIG. 1 shows a flow chart 100 of logic describing a method for generating a travel path condition prompt according to an exemplary embodiment. The method for travel path condition prompt may be applied to a device, or more particularly to a mobile device such as a smart phone, tablet, laptop computer, wearable device, or the like. As shown in FIG. 1, the method for generating the travel path condition prompt may include the following.

At 101, a condition of a travel path of a mobile device, within a predetermined range from the mobile device may be detected by the mobile device when a trigger instruction for a predetermined function in the mobile device is received. The travel path may be, for example, a road, sidewalk, or other travel path environment that may exist as a travel path for the mobile device. The predetermined range may be, for example, a known range for an environmental sensor included in the mobile device that is being controlled to detect the condition of the travel path. The environmental sensor may be, for example, an image capturing device. The environmental sensor may also be, for example, a proximity sensor such as a sonar based sensor, an ultrasonic based senor, a lidar based sensor, an infrared based sensor, or another sensor capable of detecting a distance or objects within a surrounding environment of the mobile device.

At 102, prompt information may be presented on the mobile device when an obstacle (e.g., a predetermined object such as an obstacle) is determined to be detected on the travel path within the predetermined range. The prompt information may be, for example, a prompt message or other visual indicator for indicating the identification of the object within the predetermined range of the mobile device.

The condition of the travel path within the predetermined range may be detected when a trigger instruction for the predetermined function in the mobile device is received, and the prompt information may be presented when the object is determined to be located on the travel path within the predetermined range. As a result, the condition of the travel path within the predetermined range of the mobile device may be automatically detected, the user may thus be provided with a simpler method for travel path condition detection. The prompt information may be output according to the detected condition to prompt the user to pay attention to the travel path, and thus the user may avoid the detected obstacle.

According to some embodiments, detecting the condition of the travel path within the predetermined range may include determining a distance between the mobile device and a nearest object and determining that there is an obstacle on the travel path within the predetermined range when the distance to the nearest object is within the predetermined range. In other words, the nearest object may be determined to be an obstacle when the nearest object is within the predetermined range from the mobile device. According to some embodiments, detecting the condition of the travel path within the predetermined range may include determining an area, volume, shape, or other estimated physical characteristic of an object on the travel path within the predetermined range and determining that there is an obstacle on the travel path within the predetermined range when the area, volume, shape, or other estimated physical characteristic of the object is greater than a first predetermined threshold (e.g., threshold area).

According to some embodiments, outputting the prompt information when a predetermined object (e.g., obstacle) is identified and determined to be located on the travel path within the predetermined range may include obtaining a pre-stored first voice prompt file and playing the first voice prompt file to be output through a speaker on the mobile device. According to some embodiments, outputting the prompt information when there is a predetermined object (e.g., obstacle) on the travel path within the predetermined range may include generating a second voice prompt file according to the detected condition of the travel path within the predetermined range and playing the second voice prompt file to be output through a speaker on the mobile device. According to some embodiments, outputting the prompt information when there is a predetermined object (e.g., obstacle) on the travel path within the predetermined range may include generating a third voice prompt file according to the detected condition of the travel path within the predetermined range and a measured speed of the mobile device, and playing the third voice prompt file to be output through a speaker on the mobile device. According to some embodiments, outputting the prompt information when there is a predetermined object (e.g., obstacle) on the travel path within the predetermined range may include controlling an on-off state of an indicator light on the mobile device according to a predetermined frequency to control the indicator light to flicker according to the predetermined frequency. The movement speed of the mobile device may be obtained based on differences in location of the mobile device measured by a global positioning system (GPS) tracking unit included in the mobile device measured against a time measurement for the movement between the different locations.

According to some embodiments, generating the third voice prompt file according to the detected condition of the travel path within the predetermined range and the measured speed of the mobile device may include obtaining the movement speed of the mobile device. Then based on the distance between the mobile device and the nearest obstacle and the measured speed, calculating a time for a user operating the mobile device to arrive at the nearest obstacle. Then generating the third voice prompt file according to the calculated time and the measured speed when the calculated time is smaller than a second predetermined threshold time.

Optionally, detecting the condition of the travel path within the predetermined range when a trigger instruction for a predetermined function in a mobile device is received may include: when a trigger instruction for a flashlight application in the mobile device is received, initiating a proximity sensor provided on the mobile device to detect the condition of the travel path within the predetermined range. The proximity sensor may be an infrared proximity sensor or an ultrasonic proximity sensor.

Features in the above optional technical solutions may be combined in any form to form further embodiments of the disclosure which will not be detailed herein.

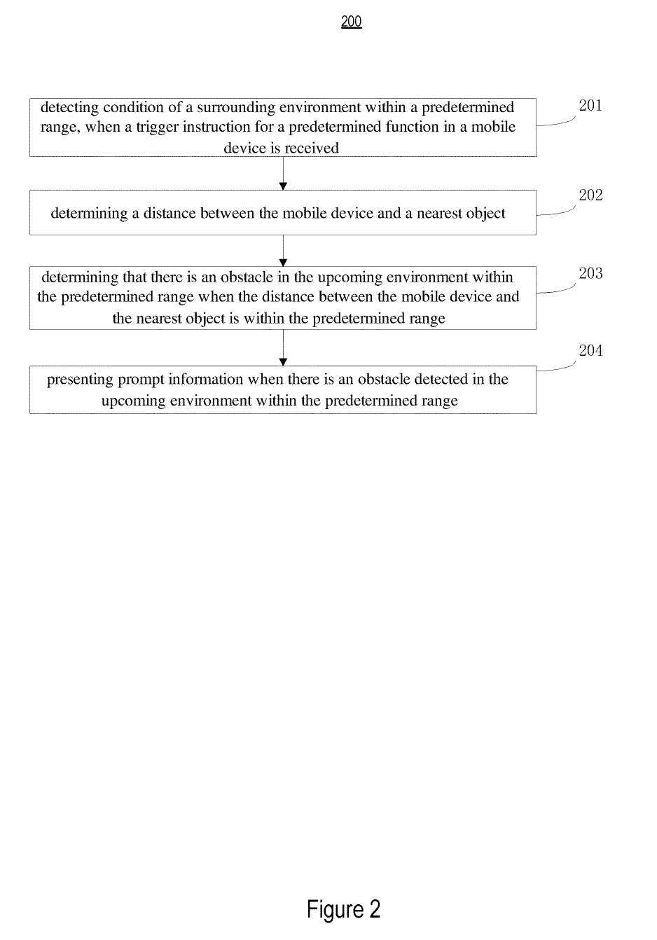

FIG. 2 shows a flow chart 200 of logic describing a method for generating an environmental condition prompt which may be used in a device (e.g., mobile device) according to an exemplary embodiment. As shown by the flow chart 200 in FIG. 2, the method may include the following.

At 201, a condition of a surrounding environment (e.g., a travel path) within a predetermined range from the device may be detected when a trigger instruction for a predetermined function in the device is received. The trigger instruction may be manual user input, or an automatic generation based on measurements sensed from sensors (e.g., measurement of a predetermined distance to an object).

The predetermined function may be, but is not limited to, a built-in function of the device or a function provided by an application installed in the device. For example, the predetermined function may be a flashlight application provided by the device controlling activation of a light on the device. The condition of the surrounding environment within the predetermined range of the device may be detected when activation of the flashlight application is detected by the device. In addition or alternatively, the predetermined function may be a travel path condition detection function provided by a condition detection application installed in the device. The travel path condition detection application may detect an surrounding environment condition by controlling environmental sensors included on the device. The condition of the surrounding environment within the predetermined range of the device may be detected when a start, or other predetermined activity, of the condition detection application is detected. Accordingly, the trigger instruction for the predetermined functions may be, but is not limited to, a trigger instruction for the flashlight application, a trigger instruction for the travel path condition detection application, and the like.

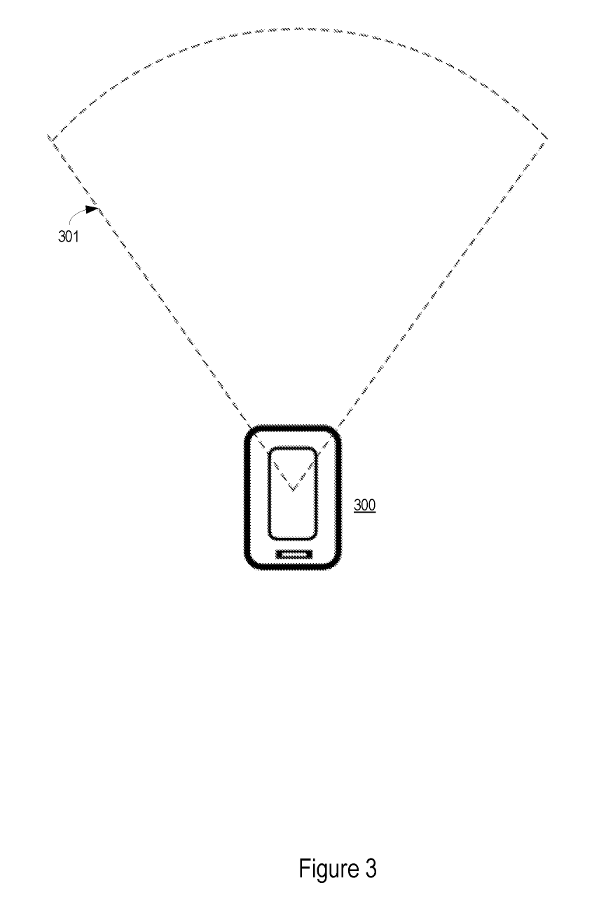

The predetermined range may include a sector region right ahead of the device with a predetermined radius. The formation of the predetermined range may not be specifically limited by the embodiment. The predetermined radius which determines the size of the sector region may be set as required. The size of the predetermined range is not specifically limited by the embodiment. For example, FIG. 3 shows an exemplary device 300 (e.g., a mobile device) and a representation of an exemplary range 301 of an environmental sensor on the device 300, where the range 301 of the environmental sensor may be referenced as the predetermined range for the device 300.

The condition of the surrounding environment (e.g., a travel path within the surrounding environment) within the predetermined range of the device may be detected when, for example, receiving a trigger instruction based on the flashlight application of the device. The condition of the surrounding environment may be detected by, for example, controlling an environmental sensor provided in the device to detect a condition of the surrounding environment within the predetermined range. The environmental sensor may be, for example, an image capturing device or a proximity sensor, such as a ultrasonic based sensor, a lidar based sensor, an infrared based sensor, or another sensor capable of detecting a distance or objects within a surrounding environment of the mobile device. The environmental sensor may detect an object in the surrounding environment located within the predetermined range and measure the distance between the object in the surrounding environment and the device. The object may be an obstacle to the user such as a protrusion on the road, holes in the road, water on the road, oil spots on the road, rock formations on the road, objects, and the like on the road. An image recognition application running on the device may receive the condition information detected by the environmental sensor that identifies the object and perform an image recognition analysis that determines the object to be, for example, an obstacle. An obstacle may be an object such as a protrusion on the road, holes in the road, water on the road, oil spots on the road, rock formations on the road, or other object determined to have an area or volume greater than a predetermined threshold area or volume.

If the device is equipped with both an infrared proximity sensor and a ultrasonic proximity sensor, the infrared proximity sensor and the ultrasonic proximity sensor may cooperate to detect the condition of the travel path in the surrounding environment, which is not specifically limited by the embodiment. The infrared proximity sensor and the ultrasonic proximity sensor may be installed on a rear camera of the device or somewhere else of the device, which is not specifically limited by the embodiment.

At 202 in flow chart 200, a distance between the device and a nearest object may be determined.

When detecting the travel path condition by a ultrasonic proximity sensor, the ultrasonic proximity sensor may transmit a sound wave ahead of the mobile device, which will reach the object and be reflected back to the ultrasonic proximity sensor so that the ultrasonic proximity sensor may receive an echo. The propagation speed of the sound wave in the air may be known and stored on a memory of the device, and the time interval between the ultrasonic proximity sensor transmitting the sound wave and receiving the echo may also be determined Then based on these pieces of information, the distance between the device and objects surrounding the device may therefore be calculated. The smallest distance detected between the device and a detected object from all the calculated distances may be determined as the distance between the device and the nearest object.

When detecting the condition by an infrared proximity sensor, or other similar environmental sensor included on the device for detecting a distance between the device and an object, the distances between the device and surrounding objects may be calculated in a similar manner.

At 203, a determination is made that there is an obstacle on the travel path within the predetermined range when the distance is within the predetermined range.

As an example, the predetermined range may be the sector region directly ahead of the device with a predetermined radius. When the calculated distance is smaller than the predetermined radius and the nearest object is within an angle smaller than a predetermined angle to the device, the nearest object may be determined to be within the predetermined range, and the determination may be made that the detected object is an obstacle positioned within the predetermined range from the device. For example, the determination may find that a the obstacle is positioned on the surrounding travel path within the predetermined range. When the calculated distance is determined to be greater than the predetermined radius or the angle is not smaller than the predetermined angle, a determination may be made that there is no obstacle within the predetermined range.

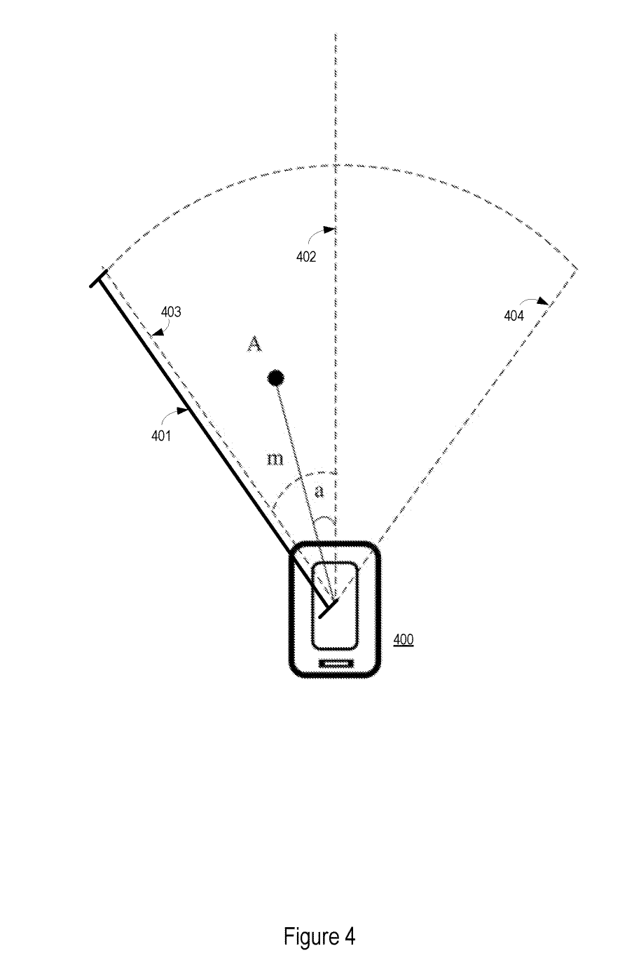

For example, FIG. 4 shows an exemplary environment that includes exemplary device 400 (e.g., a mobile device) having an exemplary predetermined range that is represented by a radius 401 of a sector region that represents a space where the device 400 is able to detect a condition of the environment within the space defined by the sector region. The sector region may be defined at least by left border line 403 and right border line 404, and an axis line 402. An object A within the surrounding environment in the sector region may be detected by an environmental sensor of the device 400. The distance between object A and the device 400 is less than the radius 401 of the sector region. That is, the distance between object A and the device 400 is less than the predetermined range. Angle a that is measured as the angle between a line connecting object A and the device 400, and the axis line 402 of the device 400, is less than predetermined angle m that is measured as the angle between the axis line 402 and the left border line 403 of the sector region, that is, the angle a is smaller than the predetermined angle m, where the predetermined angle m corresponds to half the arc angle (angle corresponding to 2 m degrees, or the angle between the left border line 403 and the right border line 404) of the arc distance corresponding to the sector region. Therefore as shown in FIG. 4, object A is positioned within the predetermined range of device 400, and the determination may be made that there is an obstacle on the surrounding environment (e.g., travel path) within the predetermined range of device 400.

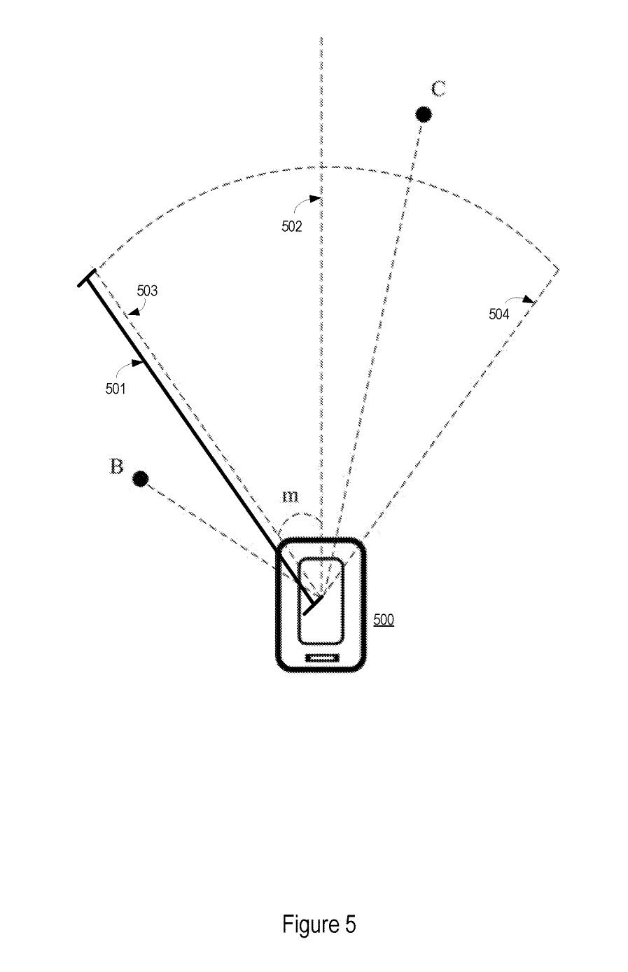

FIG. 5 shows an exemplary environment that includes exemplary device 500 (e.g., a mobile device) having an exemplary predetermined range that is represented by a radius 501 of a sector region that represents a space where the device 500 is able to detect a condition of the environment within the space defined by the sector region. The sector region may be defined at least by left border line 503 and right border line 504, and an axis line 502. In FIG. 5, the distance between object B and the device 500 is smaller than the radius 501 of the sector region. Further, the angle between the axis line 502 and the line connecting object B and the device 500 is greater than predetermined angle m, that is, the angle is greater than the predetermined angle m, where the predetermined angle m corresponds to the arc angle (angle corresponding to 2 m degrees, or the angle between the left border line 503 and the right border line 504) of the arc distance corresponding to the sector region. Therefore as shown in FIG. 5, object B is not within the predetermined range of device 500. The angle for object C calculated as the angle between the axis line 502 and the line connecting object C and the device 500, is smaller than angle m. However, the distance between obstacle C and the device 500 is greater than the radius 501 of the sector region, and thus object C is not within the predetermined range of device 500.

The above processes described at 202-203 illustrate the procedure of determining whether there is an obstacle, such as a predetermined object, on the surrounding environment (e.g. travel path) within the predetermined range of the device. Alternatively, when determining whether there is an obstacle, in the surrounding environment (e.g. travel path) within the predetermined range of the device, an area of an object detected within the predetermined range of the device may also be determined. Although an area of the detected object is calculated and referenced for exemplary purposes, it is also within the scope of this disclosure for a volume, shape, or other estimated physical characteristic of the detected object to be used in place of the area of the detected object. If a detected object is determined to have an area greater than a first predetermined threshold, the determination may be made that there is an obstacle on the surrounding environment within the predetermined range. The above method may be applied, for example, in the case where the object is a hole located on the surrounding road. The first threshold may be set as required, such as, 0.1 square meter, and is not specifically limited by the embodiment. Additionally, the above manners to determine whether there is any roadblock on the surrounding environment within the predetermined range may be combined with each other to improve the accuracy of object detection in the surrounding environment, and in particular obstacle detection in the travel path.

Referring back to flow chart 200, at 204, prompt information may be output when an obstacle is determined to be located within the predetermined range of the device.

The prompt information may be output according to one or more of the following procedures.

According to a first exemplary embodiment, the prompt information may be output by: obtaining a pre-stored first voice prompt file from a local memory included in the device, and controlling a playing function to play the first voice prompt file, wherein the first voice prompt file includes audio data that, when played, prompts the user to pay attention to the condition of the travel path ahead.

For example, the audio content of the first voice prompt file may, when played, output an audible statement including “please pay attention to current travel path condition”. The audio content may be played one or more times to prompt the user to pay attention to the condition of the surrounding environment when there is an obstacle detected within the predetermined range, as previously described in detail.

According to a second exemplary embodiment, the prompt information may be output by: generating a second voice prompt file according to the detected condition of the surrounding environment within the predetermined range, and controlling a playing function to play the second voice prompt file.

For example, when the distance between the device and the detected object is determined to be within the predetermined range from the device, the second voice prompt file may be generated to include audio content that describes the distance between the device and the obstacle. So when the distance between the device and detected object is determined to be 5 meters the second voice prompt file may be generated to include audio content that states “obstacle is 5 meters ahead of you, please pay attention”. Playing the above second voice content may prompt the user to pay attention to the objects ahead.

According to a third exemplary embodiment, the prompt information may be output by: generating a third voice prompt file according to the detected condition of the surrounding environment within the predetermined range and a movement speed of the device, and controlling a playing function to play the third voice prompt file.

When generating the third voice prompt file, the movement speed of the device may be obtained as described herein, and the time for the device to arrive at the nearest detected object may be calculated according to the obtained movement speed of the device and the calculated distance between the device and the detected object as described herein. When the time is smaller than a second predetermined threshold, the third voice prompt file may be generated based on the time and the movement speed to prompt the user to slow down and change the direction of movement.

For example, the second predetermined threshold may be set to 5 seconds. If the device is determined to be moving at a movement speed of 2 meters/second and the distance between the device and the nearest detected object is 8 meters, the time for the user to arrive at the obstacle is calculated to be 4 seconds. Since the calculated time (4 seconds) is smaller than the second predetermined threshold (5 seconds), the third voice prompt file is generated based on the time and the movement speed. The voice content of the third voice prompt file may include audio content stating “you are moving at 2 meters per second and will encounter an obstacle in 4 seconds; please slow down and change your direction”. The above audio content may be played to prompt the user to slow down and change the direction of movement to avoid the obstacle.

According to a fourth exemplary embodiment, the prompt information may be output by: controlling an on state and an off state of an indicator light included in the device according to a predetermined frequency to control the indicator light to turn on and off in an alternating manner according to the predetermined frequency.

For example, the indicator light may include a flashlight of a camera in the device. The predetermined frequency may be set to one time per second, that is, the on-off state of the flashlight is changed every one second, such that the flashlight may flash one time per second. The control of the flashlight may be used to prompt the user to pay attention to the condition of the surrounding environment.

Alternatively, control of a vibrating motor included in the device or control of an audio sound (e.g., a ringer notification) output by a speaker of the device may also be used to prompt the user to pay attention to the condition of the surrounding environment, and the manner to output is not specifically limited by the embodiment.

It should be noted that the above manners to output may be combined to prompt the user to pay attention to the condition of the surrounding environment (e.g., travel path condition), which is not specifically limited by the embodiment. For example, any one or more output methods of the prompt information may be controlled by the device based on the detected condition and/or detected object, as described.

In the methods provided by the embodiments of the disclosure, a condition of an surrounding environment surrounding the device (e.g., a travel path) within a predetermined range of the device may be detected when a trigger instruction for a predetermined function in the device is received. Prompt information may then be output when an obstacle is detected in the surrounding environment within the predetermined range. As a result, the condition of the surrounding environment within the predetermined range of the device can be automatically detected, the user may thus be provided with a simpler and more efficient method for, for example, travel path condition detection. Additionally, since prompt information may be output according to detected results to prompt the user to pay attention to the travel path condition, an injury to the user caused by the roadblocks may be avoided.

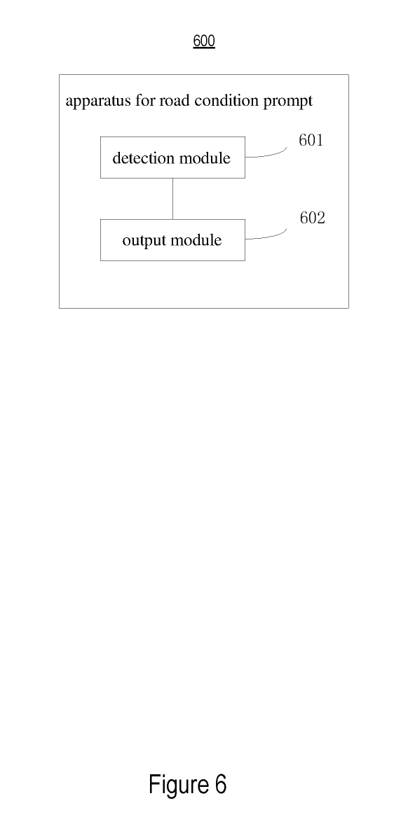

FIG. 6 shows a structure diagram illustrating an apparatus 600 for detecting a condition from an surrounding environment (e.g., travel path) of the apparatus 600 according to an exemplary embodiment. The apparatus 600 may, for example, be a mobile device, or a component included in a mobile device. Referring to FIG. 6, the device 600 may include a detection module 601 and an output module 602.

The detection module 601 may be configured to detect a condition of an surrounding environment within a predetermined range of the apparatus 600 when a trigger instruction for a predetermined function in a mobile device is received.

The output module 602 may be configured to output prompt information when a predetermined object is detected in the surrounding environment within the predetermined range based on the detected condition from the detection module 601.

In an embodiment, the detection module 601 may include either or both of the following sub-modules: a first determination sub-module and a second determination sub-module. It should be illustrated that the above sub-modules may be present separately or simultaneously, and this is not specifically limited by the embodiment.

The first determination sub-module may be configured to determine a distance between the mobile device and a nearest object, and determine that there is an obstacle in the surrounding environment within the predetermined range when the distance is within the predetermined range. The second determination sub-module may be configured to determine an area of an object detected in the surrounding environment within the predetermined range, and determine that there is an obstacle in the surrounding environment within the predetermined range when the detected object is determined to cover an area that is greater than a first predetermined threshold area.

In an embodiment, the output module 602 may include a first playing sub-module, or a second playing sub-module, or a third playing sub-module or a control module.

The first playing sub-module may be configured to obtain a pre-stored first voice prompt file and play the first voice prompt file, for example as described herein. The second playing sub-module may be configured to generate a second voice prompt file according to the condition of the surrounding environment within the predetermined range and play the second voice prompt file, for example as described herein. The third playing sub-module may be configured to generate a third voice prompt file according the condition of the surrounding environment within the predetermined range and a movement speed of the mobile device and play the third voice prompt file, for example as described herein. The control sub-module may be configured to control an on-off state of an indicator light according to a predetermined frequency to enable the indicator light to flicker according to the predetermined frequency, for example as described herein.

In an embodiment, the first voice prompt file, the second voice prompt file or the third voice prompt file may be played while the indicator light is being controlled to flicker according to the predetermined frequency. That is, the output module 602 may include the control module and any one of the first playing sub-module, the second playing sub-module and the third playing sub-module, which is not specifically limited by the embodiment.

In an embodiment, the output sub-module 602 may be configured to: obtain the movement speed of the mobile device; based on the distance between the mobile device and the nearest obstacle (e.g., predetermined object) and the movement speed, calculate time for a user to arrive at the obstacle; and generate the third voice prompt file according to the time and the movement speed if the time is smaller than a second predetermined threshold.

In an embodiment, the detection module 601 may be configured to start a proximity sensor provided on the mobile device to detect the condition of the surrounding environment within the predetermined range when a trigger instruction for a flashlight application in the mobile device is received.

In an embodiment, the proximity sensor may include an infrared proximity sensor, a lidar proximity sensor, a ultrasonic proximity sensor, and/or other environmental sensor configured to detect a distance as described herein.

In the apparatus 600, a condition of a surrounding environment (e.g., a travel path) within a predetermined range from the apparatus 600 is detected when a trigger instruction for a predetermined function in a mobile device is received, and prompt information is output when an obstacle is determined to be located in the surrounding environment within the predetermined range. As a result, the condition of the surrounding environment within the predetermined range of the mobile device can be automatically detected, the user is provided with a simpler method for surrounding environment condition detection. Additionally, since prompt information may be output according to detected results to prompt the user to pay attention to the surrounding environment condition, an injury to the user caused by the obstacle can be avoided.

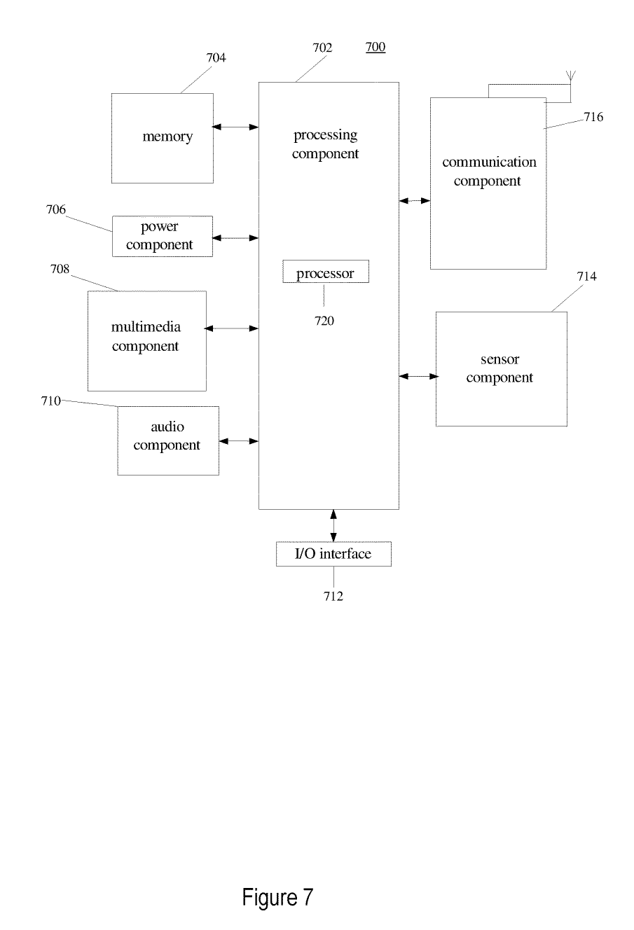

FIG. 7 shows a block diagram of a mobile device 700 according to an exemplary embodiment. For example, the mobile device 700 may be a mobile phone, a laptop computer, a desktop computer, a digital broadcast device, a messaging device, a gaming console, a tablet, a medical device, exercise equipment, a personal digital assistant, and the like.

Referring to FIG. 7, the mobile device 700 may include one or more of the following components: a processing component 702, a memory 704, a power component 706, a multimedia component 708, an audio component 710, an input/output (I/O) interface 712, a sensor component 714, and a communication component 716.

The processing component 702 typically controls overall operations of the mobile device 700, such as the operations associated with display, telephone calls, data communications, camera operations, and recording operations. The processing component 702 may include one or more processors 720 to execute instructions to perform all or part of the processes in the above described methods. Moreover, the processing component 702 may include one or more modules which facilitate the interaction between the processing component 702 and other components. For instance, the processing component 702 may include a multimedia module to facilitate the interaction between the multimedia component 708 and the processing component 702. A module may be understood to include software, hardware, middleware, and/or circuitry for implementing corresponding features.

The memory 704 is configured to store various types of data to support the operation of the mobile device 700. Examples of such data include instructions for any applications or methods operated on the mobile device 700, contact data, phonebook data, messages, pictures, video, etc. The memory 704 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 706 provides power to various components of the mobile device 700. The power component 706 may include a power management system, one or more power sources, and any other components associated with the generation, management, and distribution of power for the mobile device 700.

The multimedia component 708 includes a screen providing an output interface between the mobile device 700 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 708 includes a front camera and/or a rear camera. The front camera and the rear camera may receive an external multimedia datum while the mobile device 700 is in an operation mode, such as a photographing mode or a video mode. Each of the front camera and the rear camera may be a fixed optical lens system or have optical focusing and zooming capability.

The audio component 710 is configured to output and/or input audio signals. For example, the audio component 710 includes a microphone (“MIC”) configured to receive an external audio signal when the mobile device 700 is in an operation mode, such as a call mode, a recording mode, and a voice recognition mode. The received audio signal may be further stored in the memory 704 or transmitted via the communication component 716. In some embodiments, the audio component 710 further includes a speaker to output audio signals.

The I/O interface 712 provides an interface between the processing component 702 and peripheral interface modules, the peripheral interface modules being, for example, a keyboard, a click wheel, buttons, and the like. The buttons may include, but are not limited to, a home button, a volume button, a starting button, and a locking button.

The sensor component 714 includes one or more sensors to provide status assessments of various aspects of the mobile device 700. For instance, the sensor component 714 may detect an open/closed status of the mobile device 700, relative positioning of components (e.g., the display and the keypad, of the mobile device 700), a change in position of the mobile device 700 or a component of the mobile device 700, a presence or absence of user contact with the mobile device 700, an orientation or an acceleration/deceleration of the mobile device 700, and a change in temperature of the mobile device 700. The sensor component 714 may include a proximity sensor configured to detect the presence of a nearby object without any physical contact. The sensor component 814 may also include a light sensor, such as a CMOS or CCD image sensor, for use in imaging applications. In some embodiments, the sensor component 714 may also include an accelerometer sensor, a gyroscope sensor, a magnetic sensor, a pressure sensor, or a temperature sensor.

The communication component 716 is configured to facilitate communication, wired or wirelessly, between the mobile device 700 and other devices. The mobile device 700 can access a wireless network based on a communication standard, such as WiFi, 2G, or 3G, or a combination thereof. In an exemplary embodiment, the communication component 716 receives a broadcast signal or broadcast associated information from an external broadcast management system via a broadcast channel. In an exemplary embodiment, the communication component 716 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the mobile device 700 may be implemented in one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above methods for travel path condition prompt provided in the embodiments corresponding to FIG. 1 and FIG. 2.

In the mobile device provided by the embodiments of the disclosure, condition of, for example, a travel path within a predetermined range is detected when a trigger instruction for a predetermined function in a mobile device is received and prompt information is output if there is an obstacle on the travel path within the predetermined range. As a result, the condition of the travel path within the predetermined range of the mobile device can be automatically detected, the user is provided with a simpler method for travel path condition detection. Additionally, since prompt information may be output according to detected results to prompt the user to pay attention to the travel path condition, an injury to the user caused by the obstacle can be avoided.

In an exemplary embodiment, there is also provided a non-transitory computer-readable storage medium including instructions, such as included in the memory 704, executable by the processor 720 in the mobile device 700, for performing the above-described methods. For example, the non-transitory computer-readable storage medium may be a ROM, a RAM, a CD-ROM, a magnetic tape, a floppy disc, an optical data storage device, and the like.

A non-transitory computer readable storage medium may have stored therein instructions that, when executed by a processor of a mobile device, cause the mobile device to perform a method for travel path condition prompt, including: detecting condition of a travel path within a predetermined range when a trigger instruction for a predetermined function in a mobile device is received; and outputting prompt information if there is an obstacle on the travel path within the predetermined range.

In the computer readable storage medium provided by the embodiments of the disclosure, condition of a travel path within a predetermined range is detected when a trigger instruction for a predetermined function in a mobile device is received, and prompt information is output if there is an obstacle on the travel path within the predetermined range. As a result, the condition of the travel path within the predetermined range of the mobile device can be automatically detected, the user is provided with a simpler method for travel path condition detection. Additionally, since prompt information may be output according to detected results to prompt the user to pay attention to the travel path condition, an injury to the user caused by the roadblocks can be avoided.

Other embodiments of the invention will be apparent to those skilled in the art from consideration of the specification and practice of the disclosures herein. This application is intended to cover any variations, uses, or adaptations of the disclosure following the general principles thereof and including common sense or customary technical means in the art that is not disclosed in the disclosure. It is intended that the specification and examples be considered as exemplary only, with a true scope and spirit of the invention being indicated by the following claims.

It will be appreciated that the inventive concept is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for generating travel path prompt information on a mobile device , the method comprising:
receiving a trigger instruction by a mobile device;
in response to receiving the trigger instruction, controlling an environmental sensor of the mobile device to automatically detect a condition of a surrounding environment within a predetermined range from the mobile device;
determining whether an obstacle is identified in the surrounding environment within the predetermined range based on the detected condition; and
controlling presentation of prompt information by the mobile device when the obstacle is identified in the surrounding environment within the predetermined range.

2. The method of claim 1, wherein controlling the environmental sensor to detect the condition of the surrounding environment comprises:
determining a distance between the mobile device and a nearest object, and determining the obstacle is identified within the predetermined range when the distance between the mobile device and the nearest object is within the predetermined range; or
determining an area of an object identified in the surrounding environment within the predetermined range, and determining the obstacle is identified within the predetermined range when the area of the object is greater than a first predetermined threshold.

3. The method of claim 1, wherein controlling presentation of the prompt information comprises at least one of:
obtaining a pre-stored first voice prompt file and playing the first voice prompt file;
generating a second voice prompt file according to the detected condition of the surrounding environment within the predetermined range, and playing the second voice prompt file;
generating a third voice prompt file according to the detected condition of the surrounding environment within the predetermined range and a movement speed of the mobile device, and playing the third voice prompt file; or
controlling an indicator light included in the mobile device to switch between an on state and an off state according to a predetermined frequency.

4. The method of claim 3, wherein generating the third voice prompt file according to the detected condition of the surrounding environment within the predetermined range and the movement speed of the mobile device comprises:
obtaining the movement speed of the mobile device;
calculating, based on the distance between the mobile device and a nearest object and the movement speed, time for the mobile device to reach the nearest object; and
generating the third voice prompt file when the time is less than a second predetermined threshold.

5. The method of claim 1, wherein the trigger instruction corresponds to a state of a flashlight included in the mobile device being in an on state, and the environmental sensor comprises a proximity sensor.

6. The method of claim 5, wherein the proximity sensor comprises an infrared proximity sensor or a ultrasonic proximity sensor.

7. An apparatus for travel path condition prompt, comprising:
a processor;
a memory in communication with the processor and configured to store processor-executable instructions;
wherein the processor is configured to execute the instructions to:
receive a trigger instruction by a mobile device;
in response to receiving the trigger instruction, control an environmental sensor of the mobile device to automatically detect a condition of a surrounding environment within a predetermined range from the mobile device;
determine whether an obstacle is identified in the surrounding environment within the predetermined range based on the detected condition; and
control presentation of prompt information by the mobile device when the obstacle is identified in the surrounding environment within the predetermined range.

8. The apparatus of claim 7, wherein the processor is further configured to execute the instructions to:
determine a distance between the mobile device and a nearest object and determine that there is an obstacle on the surrounding environment within the predetermined range when the distance between the mobile device and the nearest object is within the predetermined range; or
determine an area of an object identified in the surrounding environment within the predetermined range, and determine the obstacle is identified within the predetermined range when the area of the object is greater than a first predetermined threshold.

9. The apparatus of claim 7, wherein the processor is further configured to execute the instructions to:
obtain a pre-stored first voice prompt file and playing the first voice prompt file;
generate a second voice prompt file according to the detected condition of the surrounding environment within the predetermined range, and play the second voice prompt file;
generate a third voice prompt file according to the detected condition of the surrounding environment within the predetermined range and a movement speed of the mobile device, and play the third voice prompt file; or
control an indicator light included in the mobile device to switch between an on state and an off state according to a predetermined frequency.

10. The apparatus of claim 9, wherein the processor is further configured to execute the instructions to:
obtain the movement speed of the mobile device;
calculate, based on the distance between the mobile device and a nearest object and the movement speed, time for the mobile device to reach the nearest object; and
generate the third voice prompt file when the time is less than a second predetermined threshold.

11. The apparatus of claim 7, wherein the processor is further configured to execute the instructions to control a proximity sensor included on the mobile device to detect the condition of the surrounding environment within the predetermined range when a trigger instruction corresponding to a state of a flashlight included in the mobile device being in an on state is received.

12. The apparatus of claim 11, wherein the proximity sensor comprises an infrared proximity sensor or an ultrasonic proximity sensor.

13. A non-transitory computer readable storage medium having stored therein instructions that, when executed by a processor of a mobile device, cause the mobile device to:
receive a trigger instruction by a mobile device;
in response to receiving the trigger instruction, control an environmental sensor of the mobile device to automatically detect a condition of a surrounding environment within a predetermined range from the mobile device;
determine whether an obstacle is identified in the surrounding environment within the predetermined range based on the detected condition; and
control presentation of prompt information by the mobile device when the obstacle is identified in the surrounding environment within the predetermined range.
